(19) United States
(12) Patent Application Publication
(10) Pub. No.: US 2024/0303135 A1
(43) Pub. Date: Sep. 12, 2024

(54) DATA TRANSMISSION METHOD

(71) Applicant: Alibaba (China) Co., Ltd., Hangzhou, Zhejiang (CN)

(72) Inventors: Huatao Zhao, Shanghai (CN); Shengcheng Wang, Shanghai (CN); Yunfan Li, Shanghai (CN); Lide Duan, Sunnyvale, CA (US)

(21) Appl. No.: 18/599,937

(22) Filed: Mar. 8, 2024

(30) Foreign Application Priority Data
Mar. 8, 2023 (CN) 202310246044.1

(51) Int. Cl. G06F 9/54

(52) U.S. Cl. CPC G06F 9/54

(57) ABSTRACT

Embodiments of the present disclosure provide a data transmission method. The data transmission method is applied to an operation chip. The operation chip includes a plurality of nodes of a network on chip (NoC), and the method includes: receiving a data processing instruction of target service data, where the data processing instruction carries information about a receiving node and a processing node set; determining a relay processing node in the processing node set based on the receiving node; and transmitting the target service data from the receiving node to the relay processing node, and transmitting the target service data from the relay processing node to another processing node in the processing node set.

### CROSS-REFERENCE TO RELATED APPLICATIONS

The disclosure claims the benefits of priority to Chinese Application No. 202310246044.1, filed on Mar. 8, 2023, which is incorporated herein by reference in its entirety.

### TECHNICAL FIELD

Embodiments of the present disclosure relate to the field of computer technologies, and in particular, to a data transmission method.

### BACKGROUND

A network on chip (NoC) is a new communication mode for a system-on-chip (SoC), and is a main component of multi-core technology. The NoC approach introduces a new on-chip communication method, and an NoC-based system can better adapt to the globally asynchronous and locally synchronized clock mechanism used in the future complex multi-core SoC design. However, in the NoC, a commonly used network structure is a packet-switched direct network. Each node is connected to an adjacent node through a bidirectional channel. The network connection in the NoC is heterogeneous, and the distribution of communication traffic is also uneven. When service data of related service is transmitted to the NoC, a corresponding rectangular area is allocated to the service data in the NoC, and the service data is processed based on nodes in the rectangular area.

### SUMMARY

The disclosed embodiments of the present disclosure provide a data transmission method. One or more embodiments of the present disclosure simultaneously relate to a routing node, a processing unit, and a system-on-chip (SoC), to resolve technical defects existing in the prior art.

According to some embodiments of the present disclosure, a data transmission method is provided, applied to an operation chip including a plurality of routing nodes of a network on chip (NoC), the method including: receiving a data processing instruction of target service data, wherein the data processing instruction carries information about a receiving node and a processing node set of the NoC, the receiving node being configured to receive the target service data and transmit to the processing node set, and the processing node set being configured to process the target service data; determining a relay processing node in the processing node set based on the receiving node, the relay processing node being configured to receive the target service data transmitted from the target service data; and transmitting the target service data from the receiving node to the relay processing node, and transmitting the target service data from the relay processing node to another processing node in the processing node set.

According to some embodiments of the present disclosure, a node is provided, configured in an NoC of an operation chip, where each node of the NoC is deployed in each processing unit of the NoC for data transmission between the processing units, and the routing node includes: a receiving unit includes circuitry that is configured to receive a data processing instruction of target service data, wherein the data processing instruction carries information about a receiving node and a processing node set of the NoC, the receiving node being configured to receive the target service data and transmit to the processing node set, and the processing node set being configured to process the target service data; a determination unit includes circuitry that is configured to determine a relay processing node in the processing node set based on the receiving node, the relay processing node being configured to receive the target service data transmitted from the target service data; and a transmission unit includes circuitry that is configured to transmit the target service data from the receiving node to the relay processing node, and to transmit the target service data from the relay processing node to another processing node in the processing node set.

According to some embodiments of the present disclosure, a processing unit is provided, including: a processor core; and a routing node of an NoC, where the routing node of the NoC includes the foregoing routing node.

According to some embodiments of the present disclosure, an SoC is provided, including: a plurality of processing units, where each of the processing units includes the foregoing routing node, the plurality of routing nodes form a routing node network, and the plurality of routing nodes are deployed in the plurality of processing units.

### BRIEF DESCRIPTION OF THE DRAWINGS

The accompanying drawings described herein are used for providing a further understanding of the present disclosure, and forming a part of the present disclosure. Exemplary examples of the present disclosure and descriptions thereof are used for explaining the present disclosure, but do not constitute any inappropriate limitation to the present disclosure. In the accompanying drawings.

FIG. 1 is a schematic diagram of an exemplary operation chip according to some embodiments of the present disclosure.

FIG. 2 is a flowchart illustrating a processing process of an exemplary data transmission method according to some embodiments of the present disclosure.

FIG. 3 is a schematic diagram of data transmission in an exemplary operation chip according to some embodiments of the present disclosure.

FIGS. 4A, 4B, 4C, and 4D each shows a schematic diagram of an exemplary data propagation direction according to some embodiments of the present disclosure.

FIG. 5 is a flowchart of a processing process of an exemplary data transmission method in an image processing scenario according to some embodiments of the present disclosure.

FIG. 6 is a schematic structural diagram of an exemplary routing node of a network on chip (NoC) according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms or definitions incorporated by reference.

In some of the disclosed embodiments below, a relay processing node within the set of processing nodes can be identified. This enables prompt transmission of service data to the processing node set, which can then be forwarded by the relay processing node to an intended processing node within the set of nodes to be processed, circumventing the need for further transmission within a separate processing node of the operation chip. Thus, internet bandwidth can be conserved, and a reduction in transmission delays can be achieved.

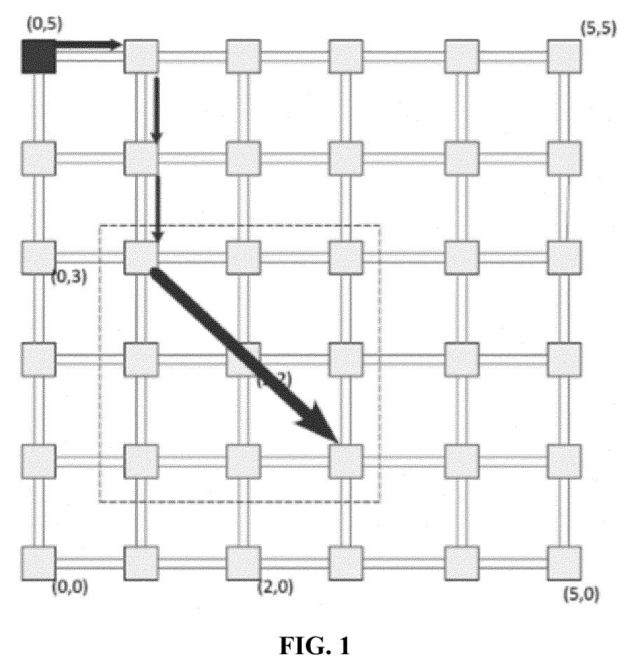

FIG. 1 is a schematic diagram of an exemplary operation chip according to some embodiments of the present disclosure. The data transmission method provided in some embodiments can be applied to the operation chip. In some embodiments, a large amount of matrix operation may be involved in the process of dealing with deep learning-related service. To increase the speed of matrix operation, a specialized operation chip is designed to accelerate the data processing operation of tensor data.

As shown in FIG. 1, the operation chip generally includes a plurality of routing nodes of a network on chip (NoC). The routing nodes of the NoC are distributed in a rectangular shape, and each routing node is linked with a corresponding number of processor groups. When service data needs to be processed, the service data may be processed on the nodes of the chip.

To facilitate management, the operation chip is usually mapped to a rectangular coordinate system, and a lower left corner of the operation chip is defined as an origin node, which is denoted as (0, 0). Based on this, each routing node in the operation chip has corresponding coordinates, for example, (0, 5), (0, 3), and (2, 0) as shown in FIG. 1.

When the service data is transmitted to the operation chip, an upstream service logic layer is configured to determine a receiving node and a processing node set of the service data on the operation chip. The receiving node refers to a node configured to receive the service data. The processing node set refers to a set of routing nodes configured to process the service data. Generally, the processing node set is a set of routing nodes in a rectangular area on the operation chip, and the set of routing nodes in a dashed rectangular frame shown in FIG. 1 is the processing node set. In some embodiments, the processing node set is usually represented by the routing node closest to the origin node and the routing node farthest from the origin node. The routing node closest to the origin node is a first reference node, and the routing node farthest from the origin node is a second reference node.

After the receiving node is determined, a routing node closest to the receiving node needs to be determined from the processing node set as a relay processing node based on the receiving node, so that service data may be directly transmitted from the receiving node to the relay processing node. This avoids invalid data transmission in the operation chip, saves the bandwidth, and reduces the delay of data transmission.

In the processing node set, the service data may be quickly transmitted inside the processing node set based on a preset data transmission policy. During transmission inside the processing node set, a waste of bandwidth resources is avoided, and efficiency of data transmission is improved.

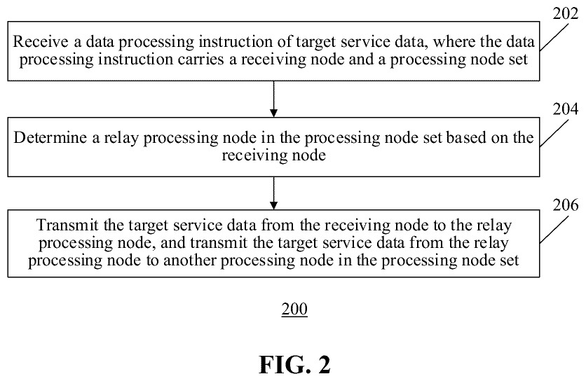

FIG. 2 is a flowchart illustrating a processing process of an exemplary data transmission method 200 according to some embodiments of the present disclosure. Method 200 can be applied to an operation chip (e.g., the operation chip in FIG. 1) which includes a plurality of routing nodes of an NoC. As shown in FIG. 2, method 200 includes the following steps 202 to 206, which can be implemented by a processing device (e.g., an apparatus equipped with a central processing unit (CPU)).

In step 202, the processing device receives a data processing instruction of target service data, where the data processing instruction carries a receiving node and a processing node set.

The target service data can be tensor computing data in deep learning model scenarios, for example, image tensor data in an image processing model, text tensor data in a text processing model, or audio tensor data in an audio processing model. In some embodiments of the present disclosure, specific contents of the target service data are not limited.

The data processing instruction can be an instruction to process the target service data. In some embodiments, the target service data is transmitted to the operation chip, and the target service data needs to be computed on a node of the operation chip. A plurality of nodes usually exist on the operation chip, and each node corresponds to a tensor processor group. For example, each node of an operation chip includes a 5*5 processor group. After the target service data is transmitted to the node, corresponding computation is performed on the target service data in the processor group corresponding to the node.

A plurality of nodes exist on the operation chip, and are configured to calculate tensors. The tensors herein may be service data corresponding to various services. When the target service data reaches the operation chip, upper-layer service processing logic determines the receiving node configured to receive the target service data, and then determines the processing node set that needs to perform operation on the target service data. The receiving node can be a node that receives the target service data in the operation chip, and the processing node set can be a set of routing nodes configured to process the target service data.

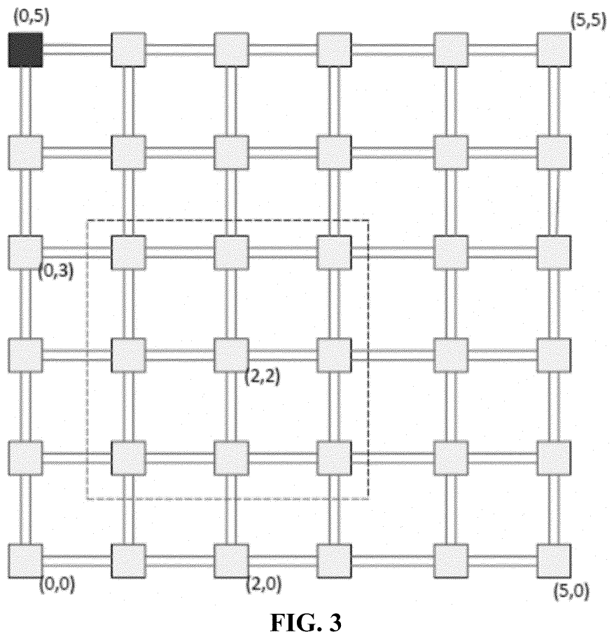

In some embodiments, the processing node set is usually a rectangular area on the operation chip. FIG. 3 is a schematic diagram of data transmission in an exemplary operation chip according to some embodiments of the present disclosure. In the operation chip shown in FIG. 3, a routing node in a lower left corner is used as the origin, which is denoted as (0, 0). When the target service data is transmitted to the operation chip for processing by upper-layer service logic, the receiving node and the processing node set of the target service data are predetermined. Generally, because the processing node set is a rectangular area, processing nodes are represented by the node closest to the origin and the node farthest from the origin in the rectangular area. For example, (0, 5) in FIG. 3 is the receiving node, and the node enclosed by a dashed rectangular frame in FIG. 3 is the processing node set. According to some embodiments of the present disclosure, the processing node set may be represented by {(1, 1), (3, 3)}, where (1, 1) is a point closest to the origin, which is denoted as the first reference node, and where (3, 3) is a point farthest from the origin, which is denoted as the second reference node. In other words, in some embodiments of the present disclosure, the processing node set can be represented by the first reference node and the second reference node.

It should be noted that the receiving node and the processing node set of the target service data is determined in advance by the upper-layer service processing logic. When the data processing instruction is transmitted to the operation chip, the receiving node and the processing node set that receive the target service data may be already determined.

Turing back to FIG. 2, in step 204, the processing device determines a relay processing node in the processing node set based on the receiving node.

The relay processing node can be a processing node located in the processing node set that receives target service data transmitted from the receiving node. For example, as for the processing node set {(1, 1), (3, 3)}, the nodes for processing the target service data include (1, 1), (1, 2), (1, 3), (2, 1), (2, 2), (2, 3), (3, 1), (3, 2), and (3, 3). The relay processing node may be any of the foregoing nodes.

Further, to improve the transmission efficiency, the processing node set needs to be searched for a processing node closest to the receiving node as the relay processing node, so that the received target service data can be quickly transmitted to the relay processing node, thereby saving the bandwidth in the operation chip.

Specifically, step 204 of determining a relay processing node in the processing node set based on the receiving node may include the following steps S2042 to S2046 (not shown in FIG. 2).

In step S2042, the processing device obtains receiving node coordinates of the receiving node, and obtains first reference node coordinates and second reference node coordinates in the processing node set.

As described in the foregoing steps, the operation chip is usually a rectangular chip. To facilitate management of the operation chip, each routing node is usually numbered. The number is usually represented by node coordinates of the node. For example, in the operation chip shown in FIG. 3, an example in which a routing node in a lower left corner is the origin is used, and the node coordinates of the origin are denoted as (0, 0). As shown in FIG. 3, the horizontal direction is the abscissa axis, and the vertical direction is the ordinate axis. The node coordinates of each routing node can be determined in sequence. When a chip located at coordinates (0, 5) is the receiving node, the coordinates of the receiving node are (0, 5).

In addition, the processing node set usually includes processing nodes in the rectangular area that process the target service data. The processing node closest to the origin node is denoted as the first reference node, and the corresponding coordinates thereof are first reference node coordinates. The processing node farthest from the origin node is denoted as the second reference node, and the corresponding coordinates thereof are the second reference node coordinates.

With further reference to FIG. 3, the routing node filled with black is the receiving node, and the receiving node coordinates are (0, 5). The processing node closest to the origin among the nodes of the rectangular frame is the first reference node, and the corresponding first reference node coordinates are (1, 1). The processing node farthest from the origin among the nodes of the rectangular frame is the second reference node, and the corresponding second reference node coordinates are (3, 3).

In step S2044, the processing device determines relay processing node coordinates based on the receiving node coordinates, the first reference node coordinates, and the second reference node coordinates.

After the receiving node coordinates, the first reference node coordinates, and the second reference node coordinates are determined, the relay processing node coordinates can be determined in the processing node set based on the three coordinates.

Specifically, the determining relay processing node coordinates based on the receiving node coordinates, the first reference node coordinates, and the second reference node coordinates may include the following steps: determining a relay abscissa based on a receiving abscissa of the receiving node coordinates, a first abscissa of the first reference node coordinates, and a second abscissa of the second reference node coordinates; determining a relay ordinate based on a receiving ordinate of the receiving node coordinates, a first ordinate of the first reference node coordinates, and a second ordinate of the second reference node coordinates; and determining relay processing node coordinates based on the relay abscissa and the relay ordinate.

In the process of determining the relay processing node coordinates, an abscissa and an ordinate of the relay processing node need to be processed separately. To be specific, the relay abscissa of the relay processing node is determined based on the receiving abscissa of the receiving node coordinates, the first abscissa of the first reference node coordinates, and the second abscissa of the second reference node coordinates.

Specifically, the determining a relay abscissa based on a receiving abscissa of the receiving node coordinates, a first abscissa of the first reference node coordinates, and a second abscissa of the second reference node coordinates may include the following steps: determining that the first abscissa is the relay abscissa in a case that the receiving abscissa is less than or equal to the first abscissa; and determining that the second abscissa is the relay abscissa in a case that the receiving abscissa is greater than the first abscissa.

The receiving abscissa is compared with the first abscissa. If the receiving abscissa is less than or equal to the first abscissa, it can be determined that the relay abscissa is the first abscissa. If the receiving abscissa is greater than the first abscissa, it can be determined that the relay abscissa is the second abscissa.

In some embodiments of the present disclosure, an example in which the first reference node coordinates are (1, 1) and the second reference node coordinates are (3, 3) is used. Correspondingly, the first abscissa is 1, and the second abscissa is 3. In a case that the receiving node coordinates are (0, 5), and the receiving abscissa is 0 and is less than the first abscissa, the relay abscissa is 1. In a case that the receiving node coordinates are (4, 4), and the receiving abscissa is 4 and greater than the first abscissa, the relay abscissa is 3. In a case that the receiving node coordinates are (2, 2), and the receiving abscissa is 2 and greater than the first abscissa, the relay abscissa is 3. In a case that the receiving node coordinates are (1, 5), and the receiving abscissa is 1 and equal to the first abscissa, the relay abscissa is 1.

Similarly, the relay ordinate of the relay processing node can be determined based on the receiving ordinate of the receiving node coordinates, the first ordinate of the first reference node coordinates, and the second ordinate of the second reference node coordinates.

Specifically, the determining a relay ordinate based on a receiving ordinate of the receiving node coordinates, a first ordinate of the first reference node coordinates, and a second ordinate of the second reference node coordinates may include the following steps: determining that the first ordinate is the relay ordinate in a case that the receiving ordinate is less than or equal to the first ordinate; and determining that the second ordinate is the relay ordinate in a case that the receiving ordinate is greater than the first ordinate.

Similar to the abscissa, the receiving ordinate is compared with the first ordinate. If the receiving ordinate is less than or equal to the first ordinate, it can be determined that the relay ordinate is the first ordinate. If the receiving ordinate is greater than the first ordinate, it can be determined that the relay ordinate is the second ordinate.

In some embodiments of the present disclosure, an example in which the first reference node coordinates are (1, 1) and the second reference node coordinates are (3, 3) is used. Correspondingly, the first ordinate is 1, and the second ordinate is 3. In a case that the receiving node coordinates are (0, 5), and the receiving ordinate is 5 and greater than the first ordinate, the relay ordinate is 3. In a case that the receiving node coordinates are (4, 4), and the receiving ordinate is 4 and greater than the first ordinate, the relay ordinate is 3. In a case that the receiving node coordinates are (2, 2), and the receiving ordinate is 2 and greater than the first ordinate, the relay ordinate is 3. In a case that the receiving node coordinates are (0, 0), and the receiving ordinate is 0 and less than the first ordinate, the relay ordinate is 1.

After the relay abscissa and the relay ordinate are determined, the relay processing node coordinates may be determined.

In some embodiments of the present disclosure, an example in which the first reference node coordinates are (1, 1) and the second reference node coordinates are (3, 3) is used. In a case that the receiving node coordinates are (0, 5), the corresponding relay processing node coordinates are (1, 3). Correspondingly, when the receiving node coordinates are (4, 4), the corresponding relay processing node coordinates are (3, 3). When the receiving node coordinates are (2, 2), the corresponding relay processing node coordinates are (3, 3). When the receiving node coordinates are (2, 1), the corresponding relay processing node coordinates are (3, 1). When the receiving node coordinates are (4, 1), the corresponding relay processing node coordinates are (3, 1). When the receiving node coordinates are (0, 0), the corresponding relay processing node coordinates are (1, 1).

In step S2046, the processing device determines a relay processing node based on the relay processing node coordinates.

After the relay processing node coordinates are determined, it can be determined that the processing node corresponding to the relay processing node coordinates in the operation chip is the relay processing node.

Turning back to FIG. 2, in step 206, the processing device transmits the target service data from the receiving node to the relay processing node, and transmits the target service data from the relay processing node to another processing node in the processing node set.

After the relay processing node is determined, the target service data can be transmitted from the receiving node to the relay processing node. It should be noted that a data volume of the target service data is relatively large generally. During transmission of the target service data, the target service data is usually encoded into a plurality of data packets, and each data packet may have a corresponding data packet number. The process of transmitting the target service data is actually a process of transmitting a plurality of data packets. For example, if a size of a data packet is 512 bits, then the target service data can be divided into a plurality of data packets with the size of 512 bits, and each data packet can be transmitted in sequence. After all the data packets are transmitted to a target processing node, the transmission is completed. In some embodiments of the present disclosure, the transmission process of the target service data can be referred to the foregoing method, and the details are not described again subsequently.

The target service data may be transmitted from the relay processing node to another processing node in the processing node set after being transmitted from the receiving node to the relay processing node. It should be noted that the target service data is to be encoded into a plurality of data packets during transmission. The relay processing node does not need to transmit all the data packets to another processing node only after obtaining all the data packets. In units of data packets, after receiving one data packet, the relay processing node may transmit the data packet in the processing node set, thereby improving transmission efficiency.

Specifically, the transmitting the target service data from the relay processing node to another processing node in the processing node set may include the following steps: determining current processing node coordinates of a current processing node, relay processing node coordinates of the relay processing node, and first reference node coordinates and second reference node coordinates in the processing node set; determining a next processing node of the target service data based on the current processing node coordinates, the relay processing node coordinates, the first reference node coordinates, and the second reference node coordinates; and transmitting the target service data from the current processing node to the next processing node.

In some embodiments, to further improve transmission efficiency of the target service data in the processing node set and avoid a waste of bandwidth, the target service data needs to be transmitted from the relay processing node to other processing nodes aggregated in a to-be-processed node set according to a preset transmission rule.

Specifically, the current processing node where the target service data is located needs to be determined first. The current processing node herein refers to the processing node to which a data packet is transmitted. For example, a data packet of the target service data is first transmitted to the relay processing node, and needs to be transmitted from the relay processing node to another processing node. In this case, the relay processing node is the current processing node. Correspondingly, when a data packet is transmitted to a processing node A, it needs to determine whether the data packet needs to be transmitted from the processing node A to another processing node. In this case, the processing node A is the current processing node, and current processing node coordinates of the current processing node are obtained.

During determining of the current processing node coordinates, the relay processing node coordinates, the first reference node coordinates, and the second reference node coordinates determined in the foregoing steps further need to be obtained. The next processing node needs to be determined based on a relationship between the current processing node coordinates, the relay processing node coordinates, the first reference node coordinates, and the second reference node coordinates.

After the next processing node is determined, the target service data continues to be transmitted from the current processing node to the next processing node. It should be noted that if the next processing node cannot be determined based on the relationship between the current processing node coordinates, the relay processing node coordinates, the first reference node coordinates, and the second reference node coordinates, then it indicates that the current processing node is the last processing node in the processing node set. In this case, the processing node set has obtained all the target service data. To be specific, the target service data is already in each processing node in the processing node set.

In some embodiments of the present disclosure, the current processing node coordinates include a current abscissa and a current ordinate, the relay processing node coordinates include a relay abscissa and a relay ordinate, the first reference node coordinates include a first abscissa and a first ordinate, and the second reference node coordinates include a second abscissa and a second ordinate.

As described in the foregoing steps, coordinates of each node include an abscissa and an ordinate. To be specific, the current processing node coordinates include the current abscissa and the current ordinate. The relay processing node coordinates, the first reference node coordinates, and the second reference node coordinates have been explained accordingly in the foregoing steps. Details are not described herein again.

Correspondingly, the determining a next processing node of the target service data based on the current processing node coordinates, the relay processing node coordinates, the first reference node coordinates, and the second reference node coordinates may include the following steps S2061 to S2066.

In step S2061, the processing device determines a first adjustment policy based on a relationship between the current abscissa and the relay abscissa.

The first adjustment policy refers to an adjustment policy determined based on a positional relationship between the current abscissa and the relay abscissa. In the process of finally determining the next processing node, a plurality of adjustment policies need to be used, and the final node adjustment policy is determined based on the plurality of adjustment policies. The first adjustment policy is determined based on the positional relationship between the current abscissa and the relay abscissa.

Specifically, the determining a first adjustment policy based on a relationship between the current abscissa and the relay abscissa includes: determining that the first adjustment policy is yes in a case that the current abscissa is equal to the relay abscissa; and determining that the first adjustment policy is no in a case that the current abscissa is not equal to the relay abscissa.

It is determined that the first adjustment policy is yes in a case that the current abscissa is equal to the relay abscissa, and it is determined that the first adjustment policy is no in a case that the current abscissa is not equal to the relay abscissa. The first adjustment policy can be used to determine whether the current abscissa is on a vertical axis corresponding to the relay abscissa.

For example, if the current abscissa is 1 and the relay abscissa is 1, then it is determined that the first adjustment policy is yes. If the current abscissa is 2 and the relay abscissa is 1, then it is determined that the first adjustment policy is no.

In step S2062, the processing device determines a second adjustment policy based on a relationship between the current ordinate and the relay ordinate.

The second adjustment policy is also the reference information for determining the final node adjustment policy, and the second adjustment policy is determined based on the positional relationship between the current ordinate and the relay ordinate.

Specifically, the determining a second adjustment policy based on a relationship between the current ordinate and the relay ordinate may include the following steps: determining that the second adjustment policy is yes in a case that the current ordinate is equal to the relay ordinate; and determining that the second adjustment policy is no in a case that the current ordinate is not equal to the relay ordinate.

Similar to the manner of determining the first adjustment policy, it is determined that the second adjustment policy is yes in a case that the current ordinate is equal to the relay ordinate, and it is determined that the second adjustment policy is no in a case that the current ordinate is not equal to the relay ordinate. The second adjustment policy can be used to determine whether the current ordinate is on a horizontal axis corresponding to the relay ordinate.

For example, if the current ordinate is 3 and the relay ordinate is 3, then it is determined that the second adjustment policy is yes. If the current ordinate is 2 and the relay ordinate is 3, then it is determined that the second adjustment policy is no.

In step S2063, the processing device determines a third adjustment policy based on a relationship among the current abscissa, the first reference abscissa, and the second reference abscissa.

The third adjustment policy can be used to determine whether the current abscissa is on a vertical axis corresponding to the first reference abscissa or the second reference abscissa.

Specifically, the determining a third adjustment policy based on a relationship among the current abscissa, the first reference abscissa, and the second reference abscissa may include the following steps: determining that the third adjustment policy is yes in a case that the current abscissa is equal to the first reference abscissa and the current abscissa is not equal to the second reference abscissa; determining that the third adjustment policy is yes in a case that the current abscissa is not equal to the first reference abscissa and the current abscissa is equal to the second reference abscissa; determining that the third adjustment policy is no in a case that the current abscissa is not equal to the first reference abscissa and the current abscissa is not equal to the second reference abscissa; and determining that the third adjustment policy is no in a case that the current abscissa is equal to the first reference abscissa and the current abscissa is equal to the second reference abscissa.

In a case that the current abscissa is the first reference abscissa or the second reference abscissa, it is determined that the third adjustment policy is yes. In a case that the current abscissa is neither the first reference abscissa nor the second reference abscissa, or both the first reference abscissa and the second reference abscissa (only one processing node in the processing node set, or a column of processing nodes), it is determined that the third adjustment policy is no.

For example, an example in which the first reference abscissa is 1 and the second reference abscissa is 3 is used. In a case that the current abscissa is 1 or 3, it is determined that the third adjustment policy is yes, and in a case that the current abscissa is 2, it is determined that the third adjustment policy is no.

For another example, an example in which the first reference abscissa is 1 and the second reference abscissa is also 1 is used. In a case that the current abscissa is 1, it is determined that the third adjustment policy is no.

In step S2064, the processing device determines a fourth adjustment policy based on a relationship among the current ordinate, the first reference ordinate, and the second reference ordinate.

The fourth adjustment policy can be used to determine whether the current ordinate is on a horizontal axis corresponding to the first reference ordinate or the second reference ordinate.

Specifically, the determining a fourth adjustment policy based on a relationship among the current ordinate, the first reference ordinate, and the second reference ordinate may include the following steps: determining that the fourth adjustment policy is yes in a case that the current ordinate is equal to the first reference ordinate and the current ordinate is not equal to the second reference ordinate; determining that the fourth adjustment policy is yes in a case that the current ordinate is not equal to the first reference ordinate and the current ordinate is equal to the second reference ordinate; determining that the fourth adjustment policy is no in a case that the current ordinate is not equal to the first reference ordinate and the current ordinate is not equal to the second reference ordinate; and determining that the fourth adjustment policy is no in a case that the current ordinate is equal to the first reference ordinate and the current ordinate is equal to the second reference ordinate.

In a case that the current ordinate is the first reference ordinate or the second reference ordinate, it is determined that the fourth adjustment policy is yes. In a case that the current ordinate is neither the first reference ordinate nor the second reference ordinate, or both the first reference ordinate and the second reference ordinate (only one processing node in the processing node set, or a row of processing nodes), it is determined that the fourth adjustment policy is no.

For example, an example in which the first reference ordinate is 1 and the second reference ordinate is 3 is used. In a case that the current ordinate is 1 or 3, it is determined that the fourth adjustment policy as yes, and in a case that the current ordinate is 2, it is determined that the fourth adjustment policy is no.

For another example, an example in which the first reference ordinate is 1 and the second reference ordinate is also 1 is used. In a case that the current ordinate is 1, it is determined that the fourth adjustment policy is no.

In step S2065, the processing device determines a node adjustment policy based on the first adjustment policy, the second adjustment policy, the third adjustment policy, and the fourth adjustment policy.

After the first adjustment policy, the second adjustment policy, the third adjustment policy, and the fourth adjustment policy are determined, the node adjustment policy may be determined based on the specific results of the four adjustment policies. Specifically, the determining a node adjustment policy based on the first adjustment policy, the second adjustment policy, the third adjustment policy, and the fourth adjustment policy may include the following steps: obtaining a preset node adjustment policy comparison table; and determining a node adjustment policy corresponding to a current node in the preset node adjustment policy comparison table based on the first adjustment policy, the second adjustment policy, the third adjustment policy, and the fourth adjustment policy.

The preset node adjustment policy comparison table refers to a corresponding node adjustment policy in the case of each pre-configured adjustment policy. Table 1 shows details of the preset node adjustment policy comparison table of some embodiments of the present disclosure.

TABLE 1

| | First | Second | Third | Fourth | Node |
|---|---|---|---|---|---|
| | adjustment | adjustment | adjustment | adjustment | adjustment |
| No. | policy | policy | policy | policy | policy |
| 1 | Yes | Yes | Yes | Yes | X, Y |
| 2 | Yes | Yes | Yes | No | X |
| 3 | Yes | Yes | No | Yes | Y |
| 4 | Yes | Yes | No | No | End |
| 5 | No | Yes | Yes | Yes | Y |
| 6 | No | Yes | Yes | No | End |
| 7 | No | Yes | No | Yes | X, Y |
| 8 | No | Yes | No | No | X |
| 9 | Yes | No | Yes | Yes | End |
| 10 | Yes | No | Yes | No | Y |
| 11 | Yes | No | No | Yes | End |
| 12 | Yes | No | No | No | Y |
| 13 | No | No | Yes | Yes | End |
| 14 | No | No | Yes | No | Y |
| 15 | No | No | No | Yes | End |
| 16 | No | No | No | No | Y |

Referring to Table 1, after each adjustment policy is determined, the corresponding node adjustment policy may be determined based on the comparison table in the foregoing Table 1. For example, when results of the four adjustment policies correspond to No. 1 in Table 1, it can be determined that the node adjustment policy in the current processing node is to make adjustments in directions X and Y, that is, to make adjustments in a horizontal direction and a vertical direction. For another example, when the results of the four adjustment policies correspond to No. 2 in Table 1, it can be determined that the node adjustment policy in the current processing node is to make adjustments in the direction X, that is, to make adjustments only in the horizontal direction. For another example, when the results of the four adjustment policies correspond to No. 3 in Table 1, it can be determined that the node adjustment policy in the current processing node is to make adjustments in the direction Y, that is, to make adjustments only in the vertical direction. For another example, when the results of the four adjustment policies correspond to No. 4 in Table 1, it can be determined that the node adjustment policy of the current processing node is end. To be specific, the current processing node is the last processing node in the processing node set, and data does not need to be transmitted to another node.

In some embodiments, the foregoing adjustment policy may be followed in each processing node until it is determined that the current processing node is the last processing node.

In step S2066, the processing device determines node coordinates of the next processing node based on the current processing node coordinates and the node adjustment policy.

After the node adjustment policy of the current processing node is determined, the node coordinates of the next processing node may be determined based on the current processing node coordinates and the node adjustment policy.

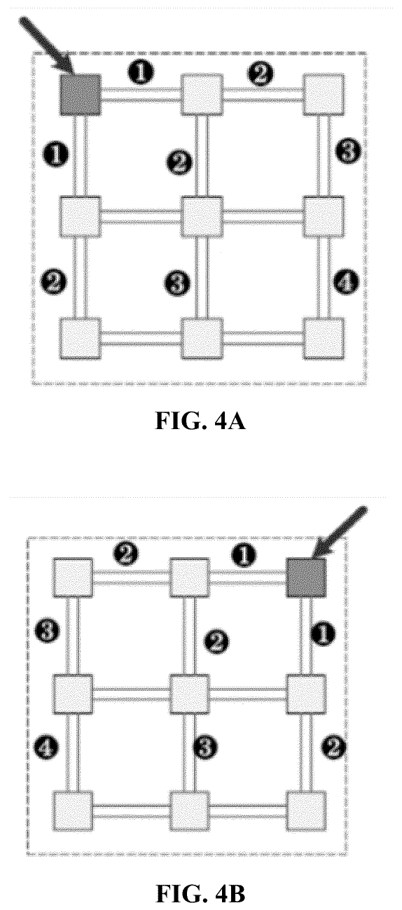

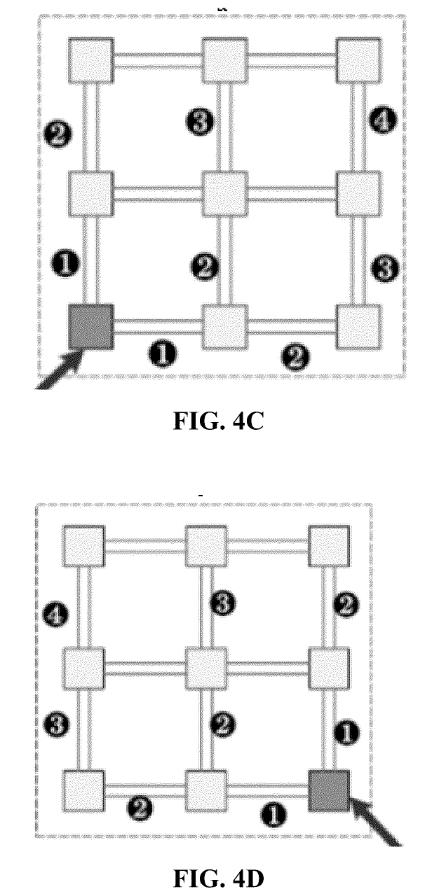

In some embodiments, the node coordinates of the next processing node are determined based on actual location information of the current processing node coordinates, and the determined next processing node is the processing node that has not received the target service data. FIGS. 4A, 4B, 4C, and 4D each shows a schematic diagram of an exemplary data propagation direction according to some embodiments of the present disclosure.

As shown in FIG. 4A, when the relay processing node is in an upper left corner of the processing node set, it is determined that a propagation direction of a next processing node is rightward and downward based on current processing node coordinates and a node adjustment policy. To be specific, the next processing node is determined based on an order of 1-2-3-4 as shown in FIG. 4A.

As shown in FIG. 4B, when the relay processing node is in an upper right corner of the processing node set, it is determined that the propagation direction of the next processing node is leftward and downward based on the current processing node coordinates and the node adjustment policy. To be specific, the next processing node is determined based on an order of 1-2-3-4 as shown in FIG. 4B.

As shown in FIG. 4C, when the relay processing node is in a lower left corner of the processing node set, it is determined that the propagation direction of the next processing node is rightward and upward based on the current processing node coordinates and the node adjustment policy. To be specific, the next processing node is determined based on an order of 1-2-3-4 as shown in FIG. 4C.

As shown in FIG. 4D, when the relay processing node is in a lower right corner of the processing node set, it is determined that the propagation direction of the next processing node is leftward and upward based on the current processing node coordinates and the node adjustment policy. To be specific, the next processing node is determined based on an order of 1-2-3-4 as shown in FIG. 4D.

In some embodiments of the present disclosure, the method may further include the following steps: determining a current processing node as a termination processing node in a case that the node adjustment policy is end; and transmitting data transmission termination information to the receiving node through the termination processing node in a case that the target service data is transmitted to the termination processing node.

In some embodiments, in a case that it is determined that the node adjustment policy corresponding to the current processing node is end, it indicates that the current processing node is already the last processing node in the processing node set. In this case, the current processing node may be determined as the termination processing node. In this case, only a detection as to whether all target service data is transmitted to the termination processing node is required. As described in the foregoing steps, the target service data is to be encoded into a plurality of data packets. When all the data packets are transmitted to the termination processing node, it can be determined that the target service data is transmitted to the termination processing node. In this case, the termination processing node is needed to transmit data transmission termination information to the receiving node. To be specific, the receiving node is notified that the target service data is all transmitted to the processing node set.

In some embodiments of the present disclosure, the method may further include: processing the target service data in the processing node set, and obtaining a data processing result.

In some embodiments, after the target service data is transmitted to each processing node in the processing node set, corresponding data processing may be performed on the target service data in the processing node set to obtain the data processing result, and the data processing result is returned to upper-layer service processing logic. In this case, the processing process of the target service data by the operation chip is completed.

It should be noted that in the process of processing the target service data, the processing node does not need to wait until all the data packets of the target service data are transmitted before processing. To be specific, in the processing node, the processes of transmitting the data packet and processing the data packet may be processed in parallel, which do not affect each other.

The data transmission method provided in the present disclosure is applied to an operation chip. The operation chip includes a plurality of routing nodes of an NoC. The method may include the following steps: receiving a data processing instruction of target service data, where the data processing instruction carries a receiving node and a processing node set; determining a relay processing node in the processing node set based on the receiving node; and transmitting the target service data from the receiving node to the relay processing node, and transmitting the target service data from the relay processing node to another processing node in the processing node set.

Through the method provided in the present disclosure, the rectangular area can be first searched for the relay processing node closest to the receiving node when the data is sent to the processing nodes in some rectangular areas of the operation chip. This ensures that the target service data may be directly transmitted to the processing node set, avoids transmission of the target service data on another node of the operation chip, and saves a bandwidth. In addition, the target service data is transmitted to another node in the processing node set by the relay processing node, which reduces a delay during the data transmission.

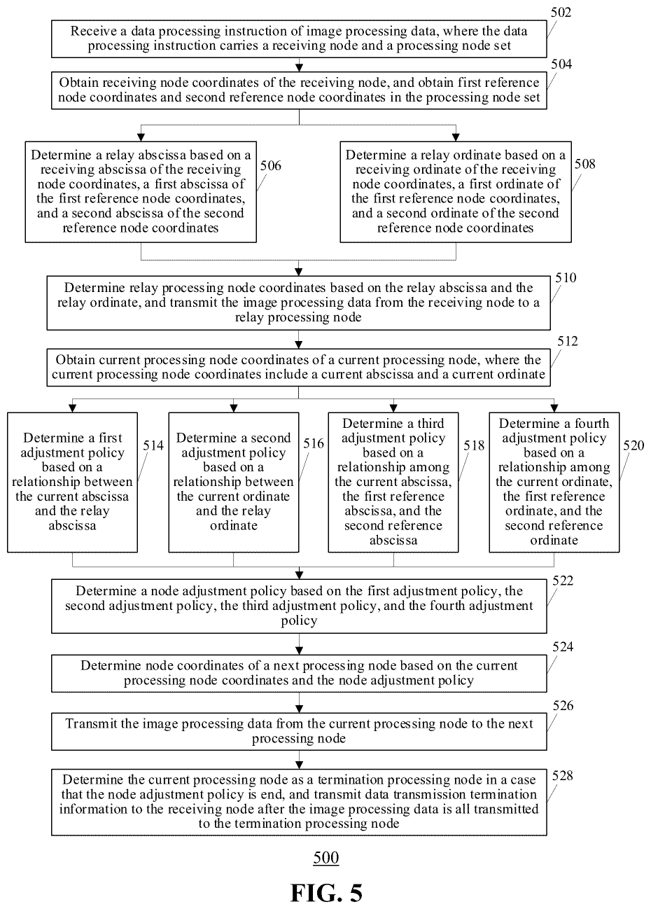

FIG. 5 is a flowchart of a processing process of an exemplary data transmission method 500 in an image processing scenario according to some embodiments of the present disclosure. Data transmission method 500 is further described below with an image processing scenario, and may include the following steps 502 to 528 which can be implemented by a processing device (e.g., an apparatus equipped with a CPU) according to the sequence shown in FIG. 5.

In step 502, the processing device receives a data processing instruction of image processing data, where the data processing instruction carries information about a receiving node and a processing node set.

In step 504, the processing device obtains receiving node coordinates of the receiving node, and obtains first reference node coordinates and second reference node coordinates in the processing node set.

In step 506, the processing device determines a relay abscissa based on a receiving abscissa of the receiving node coordinates, a first abscissa of the first reference node coordinates, and a second abscissa of the second reference node coordinates.

In step 508, the processing device determines a relay ordinate based on a receiving ordinate of the receiving node coordinates, a first ordinate of the first reference node coordinates, and a second ordinate of the second reference node coordinates.

It should be noted that step 506 and step 508 are not necessarily performed in sequence, and the two steps may be processed in parallel.

In step 510, the processing device determines relay processing node coordinates based on the relay abscissa and the relay ordinate, and transmits the image processing data from the receiving node to the relay processing node.

In step 512, the processing device obtains current processing node coordinates of a current processing node, where the current processing node coordinates include a current abscissa and a current ordinate.

In step 514, the processing device determines a first adjustment policy based on a relationship between the current abscissa and the relay abscissa.

In step 516, the processing device determines a second adjustment policy based on a relationship between the current ordinate and the relay ordinate.

In step 518, the processing device determines a third adjustment policy based on a relationship among the current abscissa, the first reference abscissa, and the second reference abscissa.

In step 520, the processing device determines a fourth adjustment policy based on a relationship among the current ordinate, the first reference ordinate, and the second reference ordinate.

It should be noted that step 512 and step 520 are not necessarily performed in sequence, and the process of determining four adjustment policies may be processed in parallel.

In step 522, the processing device determines a node adjustment policy based on the first adjustment policy, the second adjustment policy, the third adjustment policy, and the fourth adjustment policy.

In step 524, the processing device determines node coordinates of a next processing node based on the current processing node coordinates and the node adjustment policy.

In step 526, the processing device transmits the image processing data from the current processing node to the next processing node.

In step 528, the processing device determines the current processing node as a termination processing node in a case that the node adjustment policy is end, and transmits data transmission termination information to the receiving node after the image processing data is all transmitted to the termination processing node.

Through the method provided in the present disclosure, the rectangular area can be first searched for the relay processing node closest to the receiving node when image processing data is sent to the processing nodes in some rectangular areas of the operation chip. This ensures that the image processing data may be directly transmitted to the processing node set, avoids transmission of the image processing data on another node of the operation chip, and saves a bandwidth. In addition, the image processing data is transmitted to another node in the processing node set by the relay processing node, which reduces a delay during the data transmission.

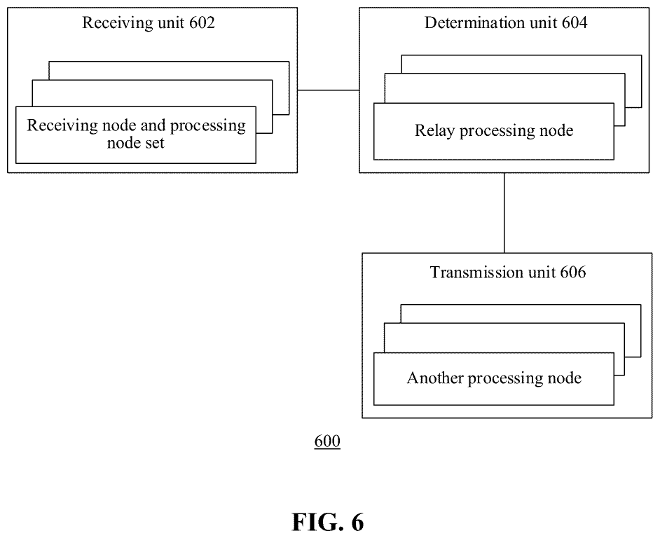

FIG. 6 is a schematic structural diagram of an exemplary routing node 600 of an NoC according to some embodiments of the present disclosure. Routing node 600 can be configured in an NoC of an operation chip. Each routing node of the NoC is deployed in each processing unit of the NoC for data transmission between the processing units. As shown in FIG. 6, routing node 600 includes a receiving unit 602, a determination unit 604, and a transmission unit 606.

Receiving unit 602 include circuitry that is configured to receive a data processing instruction of target service data, where the data processing instruction carries a receiving node and a processing node set.

Determination unit 604 include circuitry that is configured to determine a relay processing node in the processing node set based on the receiving node.

Transmission unit 606 include circuitry that is configured to transmit the target service data from the receiving node to the relay processing node, and transmit the target service data from the relay processing node to another processing node in the processing node set.

In some embodiments, determination unit 604 (specifically the include circuitry, same below) is further configured to: obtain receiving node coordinates of the receiving node, and obtain first reference node coordinates and second reference node coordinates in the processing node set; determine relay processing node coordinates based on the receiving node coordinates, the first reference node coordinates, and the second reference node coordinates; and determine a relay processing node based on the relay processing node coordinates.

In some embodiments, determination unit 604 is further configured to: determine a relay abscissa based on a receiving abscissa of the receiving node coordinates, a first abscissa of the first reference node coordinates, and a second abscissa of the second reference node coordinates; determine a relay ordinate based on a receiving ordinate of the receiving node coordinates, a first ordinate of the first reference node coordinates, and a second ordinate of the second reference node coordinates; and determine relay processing node coordinates based on the relay abscissa and the relay ordinate.

In some embodiments, determination unit 604 is further configured to: determine that the first abscissa is the relay abscissa in a case that the receiving abscissa is less than or equal to the first abscissa; and determine that the second abscissa is the relay abscissa in a case that the receiving abscissa is greater than the first abscissa.

In some embodiments, determination unit 604 is further configured to: determine that the first ordinate is the relay ordinate in a case that the receiving ordinate is less than or equal to the first ordinate; and determine that the second ordinate is the relay ordinate in a case that the receiving ordinate is greater than the first ordinate.

In some embodiments, transmission unit 606 may include the following subunits (specifically, parts of the circuitry included in transmission unit 606): a coordinate determination subunit configured to determine current processing node coordinates of a current processing node, relay processing node coordinates of the relay processing node, and first reference node coordinates and second reference node coordinates in the processing node set; a node determination subunit configured to determine a next processing node of the target service data based on the current processing node coordinates, the relay processing node coordinates, the first reference node coordinates, and the second reference node coordinates; and a transmission subunit configured to transmit the target service data from the current processing node to the next processing node.

In some embodiments, the current processing node coordinates include a current abscissa and a current ordinate, the relay processing node coordinates include a relay abscissa and a relay ordinate, the first reference node coordinates include a first abscissa and a first ordinate, and the second reference node coordinates include a second abscissa and a second ordinate.

The node determination subunit is further configured to: determine a first adjustment policy based on a relationship between the current abscissa and the relay abscissa; determine a second adjustment policy based on a relationship between the current ordinate and the relay ordinate; determine a third adjustment policy based on a relationship among the current abscissa, the first reference abscissa, and the second reference abscissa; determine a fourth adjustment policy based on a relationship among the current ordinate, the first reference ordinate, and the second reference ordinate; determine a node adjustment policy based on the first adjustment policy, the second adjustment policy, the third adjustment policy, and the fourth adjustment policy; and determine node coordinates of the next processing node based on the current processing node coordinates and the node adjustment policy.

The node determination subunit is further configured to: determine that the first adjustment policy is yes in a case that the current abscissa is equal to the relay abscissa; and determine that the first adjustment policy is no in a case that the current abscissa is not equal to the relay abscissa.

The node determination subunit is further configured to: determine that the second adjustment policy is yes in a case that the current ordinate is equal to the relay ordinate; and determine that the second adjustment policy is no in a case that the current ordinate is not equal to the relay ordinate.

The node determination subunit is further configured to: determine that the third adjustment policy is yes in a case that the current abscissa is equal to the first reference abscissa and the current abscissa is not equal to the second reference abscissa; determine that the third adjustment policy is yes in a case that the current abscissa is not equal to the first reference abscissa and the current abscissa is equal to the second reference abscissa; determine that the third adjustment policy is no in a case that the current abscissa is not equal to the first reference abscissa and the current abscissa is not equal to the second reference abscissa; and determine that the third adjustment policy is no in a case that the current abscissa is equal to the first reference abscissa and the current abscissa is equal to the second reference abscissa.

The node determination subunit is further configured to: determine that the fourth adjustment policy is yes in a case that the current ordinate is equal to the first reference ordinate and the current ordinate is not equal to the second reference ordinate; determine that the fourth adjustment policy is yes in a case that the current ordinate is not equal to the first reference ordinate and the current ordinate is equal to the second reference ordinate; determine that the fourth adjustment policy is no in a case that the current ordinate is not equal to the first reference ordinate and the current ordinate is not equal to the second reference ordinate; and determine that the fourth adjustment policy is no in a case that the current ordinate is equal to the first reference ordinate and the current ordinate is equal to the second reference ordinate.

The node determination subunit is further configured to: obtain a preset node adjustment policy comparison table; and determine a node adjustment policy corresponding to a current node in the preset node adjustment policy comparison table based on the first adjustment policy, the second adjustment policy, the third adjustment policy, and the fourth adjustment policy.

In some embodiments, routing node 600 further includes: a termination node unit configured to determine a current processing node as a termination processing node in a case that the node adjustment policy is end; and a feedback unit configured to transmit data transmission termination information to the receiving node through the termination processing node in a case that the target service data is transmitted to the termination processing node.

The routing node provided in the present disclosure is configured in the NoC of the operation chip. Each routing node of the NoC is deployed in each processing unit of the NoC for data transmission between the processing units, and includes: a receiving unit configured to receive a data processing instruction of target service data, where the data processing instruction carries a receiving node and a processing node set; a determination unit configured to determine a relay processing node in the processing node set based on the receiving node; and a transmission unit configured to transmit the target service data from the receiving node to the relay processing node, and to transmit the target service data from the relay processing node to another processing node in the processing node set.

Through the routing node provided in the present disclosure, the rectangular area is first searched for the relay processing node closest to the receiving node when the data is sent to the processing nodes in some rectangular areas of the operation chip. This ensures that the target service data may be directly transmitted to the processing node set, avoids transmission of the target service data on another node of the operation chip, and saves a bandwidth. In addition, the target service data is transmitted to another node in the processing node set by the relay processing node, which reduces a delay during the data transmission.

The foregoing is a schematic solution of a routing node of some embodiments. It should be noted that, the technical solution of the routing node and the technical solution of the foregoing data transmission method belong to the same concept. For details not described in detail in the technical solution of the routing node, reference may be made to the description of the technical solution of the foregoing data transmission method.

Some embodiments of the present disclosure further provides a processing unit, including: a processor core; and a routing node of an NoC, where the routing node of the NoC includes the foregoing routing node.

Some embodiments of the present disclosure further provides an SoC, including: a plurality of processing units, where each of the processing units includes the foregoing routing node, the plurality of routing nodes form a routing node network, and the plurality of routing nodes are deployed in the plurality of processing units.

Some embodiments of the present disclosure are described above. Other embodiments fall within the scope of the appended claims. In some cases, the actions or steps described in the claims may be performed in an order different from that in some embodiments, and may still achieve desired results. In addition, the processes depicted in the accompanying drawings are not necessarily performed in a specific order or sequential order to achieve the desired results. In some embodiments, multitasking and parallel processing are also possible or may be advantageous.

It should be noted that, for ease of description, the foregoing method embodiments are described as a series of action combinations. However, it is to be appreciated by a person skilled in the art that the embodiments of the present disclosure are not limited by the order of the described actions, because some steps may be performed in another order or simultaneously according to the embodiments of the present disclosure. Next, it is also to be appreciated by a person skilled in the art that the embodiments described in the specification all belong to preferred embodiments and the actions and modules involved are not necessarily required for the embodiments of the present disclosure.

In the foregoing embodiments, the descriptions of the embodiments have respective focuses. For a part that is not described in detail in some embodiments, reference may be made to the relevant descriptions of other embodiments.

The preferred embodiments of the present disclosure disclosed above are only used to assist in elaboration of the present disclosure. Optional embodiments do not provide an exhaustive description of all details and do not limit the present invention to only the specific implementations described. Obviously, many modifications and changes may be made based on the contents of the embodiments of the present disclosure. These embodiments are selected and specifically described in the present disclosure to better explain the principles and practical applications of the embodiments of the present disclosure, so that a person skilled in the art can better understand and utilize the present disclosure. The present disclosure is limited only by the claims and the full scope and equivalents thereof.

The embodiments may further be described using the following clauses:
1. A data transmission method, applied to an operation chip including a plurality of nodes of a network on chip (NoC), the method including:
receiving a data processing instruction of target service data, wherein the data processing instruction carries information about a receiving node and a processing node set of the NoC, the receiving node being configured to receive the target service data and transmit to the processing node set, and the processing node set being configured to process the target service data;
determining a relay processing node in the processing node set based on the receiving node, the relay processing node being configured to receive the target service data transmitted from the target service data; and
transmitting the target service data from the receiving node to the relay processing node, and transmitting the target service data from the relay processing node to another processing node in the processing node set.
2. The method according to clause 1, wherein determining the relay processing node in the processing node set based on the receiving node includes:
obtaining coordinates of the receiving node, and obtaining coordinates of a first reference node and a second reference node in the processing node set, the first reference node and the second reference node being configured to collaboratively locate the processing node set;
determining coordinates of the relay processing node based on the coordinates of the receiving node, the coordinates of the first reference node, and the coordinates of the second reference node; and
determining the relay processing node based on the coordinates of the relay processing node.
3. The method according to clause 2, wherein determining the coordinates of the relay processing node includes:
determining an abscissa of the coordinates of the relay processing node based on an abscissa of the coordinates of the receiving node, an abscissa of the coordinates of the first reference node, and an abscissa of the coordinates of second reference node;
determining an ordinate of the coordinates of the relay processing node based on an ordinate of the coordinates of the receiving node, an ordinate of the coordinates of the first reference node, and an ordinate of the coordinates of the second reference node; and
determining coordinates of the relay processing node based on the abscissa and the ordinate of the relay processing node.
4. The method according to clause 3, wherein determining the abscissa of the coordinates of the relay processing node includes:
determining that the abscissa of the coordinates of the first reference node is the abscissa of the coordinates of the relay processing node in a case that the abscissa of the coordinates of the receiving node is less than or equal to the abscissa of the coordinates of the first reference node; or
determining that the abscissa of the coordinates of the second reference node is the abscissa of the relay processing node in a case that the abscissa of the coordinates of the receiving node is greater than the abscissa of the coordinates of the first reference node.
5. The method according to clause 3, wherein determining the ordinate of the coordinates of the relay processing node includes:
determining that the ordinate of the coordinates of the first reference node is the ordinate of the relay processing node in a case that the ordinate of the coordinates of the receiving node is less than or equal to the ordinate of the coordinates of the first reference node; or
determining that the ordinate of the coordinates of the second reference node is the ordinate of the relay processing node in a case that the ordinate of the coordinates of the receiving node is greater than the ordinate of the coordinates of the first reference node.
6. The method according to any of clauses 2 to 5, wherein transmitting the target service data from the relay processing node to another processing node in the processing node set includes:
determining coordinates of a current processing node, coordinates of the relay processing node, and coordinates of the first reference node and coordinates of the second reference node in the processing node set;
determining a next processing node of the target service data based on the coordinates of the current processing node, the coordinates of the relay processing node, the coordinates of the first reference node, and the coordinates of the second reference node; and
transmitting the target service data from the current processing node to the next processing node.
7. The method according to clause 6, wherein the coordinates of the current processing node include an abscissa and an ordinate of the current processing node, the coordinates of the relay processing node include an abscissa and an ordinate of the relay processing node, the coordinates of the first reference node include an abscissa and an ordinate of the first reference node, and the coordinates of second reference node include an abscissa and an ordinate of the second reference node; and
wherein determining the next processing node of the target service data includes:
   determining a first adjustment policy based on a relationship between the abscissa of the current processing node and the abscissa of the relay processing node;
   determining a second adjustment policy based on a relationship between the ordinate of the current processing node and the ordinate of the relay processing node;
   determining a third adjustment policy based on a relationship among the abscissa of the current processing node, the abscissa of the first reference node, and the abscissa of the second reference node;
   determining a fourth adjustment policy based on a relationship among the ordinate of the current processing node, the ordinate of the first reference node, and the ordinate of the second reference node;
   determining a fifth adjustment policy based on the first adjustment policy, the second adjustment policy, the third adjustment policy, and the fourth adjustment policy; and
   determining coordinates of the next processing node based on the coordinates of the current processing node and the fifth adjustment policy.
8. The method according to clause 7, wherein determining the first adjustment policy includes:
determining that the first adjustment policy is yes in a case that the abscissa of the current processing node is equal to the abscissa of the relay processing node; or
determining that the first adjustment policy is no in a case that the abscissa of the current processing node is not equal to the abscissa of the relay processing node.
9. The method according to clause 7, wherein determining the second adjustment policy includes:
determining that the second adjustment policy is yes in a case that the ordinate of the current processing node is equal to the ordinate of the relay processing node; or
determining that the second adjustment policy is no in a case that the ordinate of the current processing node is not equal to the ordinate of the relay processing node.
10. The method according to clause 7, wherein determining the third adjustment policy includes:
determining that the third adjustment policy is yes in a case that the abscissa of the current processing node is equal to the abscissa of the first reference node and the abscissa of the current processing node is not equal to the abscissa of the second reference node;
determining that the third adjustment policy is yes in a case that the abscissa of the current processing node is not equal to the abscissa of the first reference node and the abscissa of the current processing node is equal to the abscissa of the second reference node;
determining that the third adjustment policy is no in a case that the abscissa of the current processing node is not equal to the abscissa of the first reference node and the abscissa of the current processing node is not equal to the abscissa of the second reference node; or
determining that the third adjustment policy is no in a case that the abscissa of the current processing node is equal to the abscissa of the first reference node and the abscissa of the current processing node is equal to the abscissa of the second reference node.
11. The method according to clause 7, wherein determining the fourth adjustment policy includes:
determining that the fourth adjustment policy is yes in a case that the ordinate of the current processing node is equal to the ordinate of the first reference node and the ordinate of the current processing node is not equal to the ordinate of the second reference node;
determining that the fourth adjustment policy is yes in a case that the ordinate of the current processing node is not equal to the ordinate of the first reference node and the ordinate of the current processing node is equal to the ordinate of the second reference node;
determining that the fourth adjustment policy is no in a case that the ordinate of the current processing node is not equal to the ordinate of the first reference node and the ordinate of the current processing node is not equal to the ordinate of the second reference node; and
determining that the fourth adjustment policy is no in a case that the ordinate of the current processing node is equal to the ordinate of the first reference node and the ordinate of the current processing node is equal to the ordinate of the second reference node.
12. The method according to clause 7, further including:
determining a current processing node as a termination processing node in a case that the fifth adjustment policy shows the current processing node is an end node for processing the target service data; and
transmitting data transmission termination information to the receiving node through the termination processing node in a case that the target service data is transmitted to the termination processing node.
13. The method according to any of clauses 2 to 12, wherein the processing node set includes nodes that are arranged in a rectangle manner, and an origin node located in a corner of the rectangle, and
wherein the first reference node is a node closest to the node located in lower left corner, and the second reference node is a node farthest from the node located in lower left corner.
14. The method according to clause 13, wherein the origin node is located in a lower left corner of the rectangle.
15. A node, configured in an NoC of an operation chip, wherein each node of the NoC is deployed in each processing unit of the NoC for data transmission between the processing units, and the node includes:
a receiving unit includes circuitry that is configured to receive a data processing instruction of target service data, wherein the data processing instruction carries information about a receiving node and a processing node set of the NoC, the receiving node being configured to receive the target service data and transmit to the processing node set, and the processing node set being configured to process the target service data;
a determination unit includes circuitry that is configured to determine a relay processing node in the processing node set based on the receiving node, the relay processing node being configured to receive the target service data transmitted from the target service data; and
a transmission unit includes circuitry that is configured to transmit the target service data from the receiving node to the relay processing node, and to transmit the target service data from the relay processing node to another processing node in the processing node set.
16. The node according to clause 15, wherein the circuitry of the determination unit is further configured to:
obtain coordinates of the receiving node, and obtaining coordinates of a first reference node and a second reference node in the processing node set, the first reference node and the second reference node being configured to collaboratively locate the processing node set;
determine coordinates of the relay processing node based on the coordinates of the receiving node, the coordinates of the first reference node, and the coordinates of the second reference node; and
determine the relay processing node based on the coordinates of the relay processing node.
17. The node according to clause 15, wherein the circuitry of the determination unit is further configured to:
determine an abscissa of the coordinates of the relay processing node based on an abscissa of the coordinates of the receiving node, an abscissa of the coordinates of the first reference node, and an abscissa of the coordinates of second reference node;
determine an ordinate of the coordinates of the relay processing node based on an ordinate of the coordinates of the receiving node, an ordinate of the coordinates of the first reference node, and an ordinate of the coordinates of the second reference node; and
determine coordinates of the relay processing node based on the abscissa and the ordinate of the relay processing node.
18. The node according to clause 17, wherein the circuitry of the determination unit is further configured to:
determine that the abscissa of the coordinates of the first reference node is the abscissa of the coordinates of the relay processing node in a case that the abscissa of the coordinates of the receiving node is less than or equal to the abscissa of the coordinates of the first reference node; and
determine that the abscissa of the coordinates of the second reference node is the abscissa of the relay processing node in a case that the abscissa of the coordinates of the receiving node is greater than the abscissa of the coordinates of the first reference node.
19. The node according to clause 17, wherein the circuitry of the determination unit is further configured to:
determining that the ordinate of the coordinates of the first reference node is the ordinate of the relay processing node in a case that the ordinate of the coordinates of the receiving node is less than or equal to the ordinate of the coordinates of the first reference node; and
determining that the ordinate of the coordinates of the second reference node is the ordinate of the relay processing node in a case that the ordinate of the coordinates of the receiving node is greater than the ordinate of the coordinates of the first reference node.
20. A processing unit, including:
a processor core; and
a node of an NoC according to any of clauses 15 to 19.
21. A system-on-chip (SoC), including:
a plurality of processing units, wherein each of the processing units includes the node according to any of clauses 15 to 19, the plurality of nodes form a routing node network, and the plurality of nodes are deployed in the plurality of processing units.

It is to be noted that, the terms such as “first” and “second” in the specification and claims of this disclosure and the above accompanying drawings are used for distinguishing similar objects but not necessarily used for describing particular order or sequence. It is to be understood that such used data is interchangeable where appropriate so that the examples of this disclosure described here can be implemented in an order other than those illustrated or described here. Moreover, the terms “include”, “have” and any other variants thereof mean to cover the non-exclusive inclusion. For example, a process, method, system, product, or device that includes a list of steps or units is not necessarily limited to those expressly listed steps or units, but may include other steps or units not expressly listed or inherent to such a process, method, system, product, or device.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It is to be understood that the disclosed technical content may be implemented in other ways. The apparatus embodiments described above are only schematic. For example, the division of the units is only a logical function division. In actual implementations, there may be another division manner. For example, multiple units or components may be combined or integrated into another system, or some features can be ignored or not implemented. In addition, the displayed or discussed mutual coupling or direct coupling or communication connection may be indirect coupling or communication connection through some interfaces, units, or modules, which may be in electrical or other forms.

The units described as separate components may or may not be physically separated, and the components displayed as units may or may not be physical units, that is, they may be located in one place or may be distributed to a plurality of network units. Part of or all the units may be selected according to actual needs to achieve the purpose of the solution described in some embodiments of the present disclosure.

In addition, the functional units in various embodiments of the present disclosure may be integrated into one processing unit, or each unit may exist alone physically, or two or more units may be integrated into one unit. The integrated units described above may be implemented either in the form of hardware or in the form of a software functional unit.

If the integrated units are implemented in the form of a software functional unit and sold or used as an independent product, they may be stored in a quantum computer-readable storage medium. Based on such an understanding, the technical solutions of the present disclosure essentially, or the part making contributions to the prior art, or all or part of the technical solutions may be embodied in the form of a software product. The quantum computer software product is stored in a storage medium and includes several instructions used for causing a quantum computer device to execute all or part of steps of the methods in various embodiments of the present disclosure.

The foregoing descriptions are merely preferred implementations of the present disclosure. It is to be noted that a plurality of improvements and refinements may be made by those of ordinary skill in the technical field without departing from the principle of the present disclosure, and shall fall within the scope of protection of the present disclosure.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A data transmission method, applied to an operation chip comprising a plurality of nodes of a network on chip (NoC), the method comprising:
receiving a data processing instruction of target service data, wherein the data processing instruction carries information about a receiving node and a processing node set of the NoC, the receiving node being configured to receive the target service data and transmit to the processing node set, and the processing node set being configured to process the target service data;
determining a relay processing node in the processing node set based on the receiving node, the relay processing node being configured to receive the target service data transmitted from the target service data; and
transmitting the target service data from the receiving node to the relay processing node, and transmitting the target service data from the relay processing node to another processing node in the processing node set.

2. The method according to claim 1, wherein determining the relay processing node in the processing node set based on the receiving node comprises:
obtaining coordinates of the receiving node, and obtaining coordinates of a first reference node and a second reference node in the processing node set, the first reference node and the second reference node being configured to collaboratively locate the processing node set;
determining coordinates of the relay processing node based on the coordinates of the receiving node, the coordinates of the first reference node, and the coordinates of the second reference node; and
determining the relay processing node based on the coordinates of the relay processing node.

3. The method according to claim 2, wherein determining the coordinates of the relay processing node comprises:
determining an abscissa of the coordinates of the relay processing node based on an abscissa of the coordinates of the receiving node, an abscissa of the coordinates of the first reference node, and an abscissa of the coordinates of second reference node;
determining an ordinate of the coordinates of the relay processing node based on an ordinate of the coordinates of the receiving node, an ordinate of the coordinates of the first reference node, and an ordinate of the coordinates of the second reference node; and
determining coordinates of the relay processing node based on the abscissa and the ordinate of the relay processing node.

4. The method according to claim 3, wherein determining the abscissa of the coordinates of the relay processing node comprises:
determining that the abscissa of the coordinates of the first reference node is the abscissa of the coordinates of the relay processing node in a case that the abscissa of the coordinates of the receiving node is less than or equal to the abscissa of the coordinates of the first reference node; or
determining that the abscissa of the coordinates of the second reference node is the abscissa of the relay processing node in a case that the abscissa of the coordinates of the receiving node is greater than the abscissa of the coordinates of the first reference node.

5. The method according to claim 3, wherein determining the ordinate of the coordinates of the relay processing node comprises:
determining that the ordinate of the coordinates of the first reference node is the ordinate of the relay processing node in a case that the ordinate of the coordinates of the receiving node is less than or equal to the ordinate of the coordinates of the first reference node; or
determining that the ordinate of the coordinates of the second reference node is the ordinate of the relay processing node in a case that the ordinate of the coordinates of the receiving node is greater than the ordinate of the coordinates of the first reference node.

6. The method according to claim 2, wherein transmitting the target service data from the relay processing node to another processing node in the processing node set comprises:
determining coordinates of a current processing node, coordinates of the relay processing node, and coordinates of the first reference node and coordinates of the second reference node in the processing node set;
determining a next processing node of the target service data based on the coordinates of the current processing node, the coordinates of the relay processing node, the coordinates of the first reference node, and the coordinates of the second reference node; and
transmitting the target service data from the current processing node to the next processing node.

7. The method according to claim 6, wherein the coordinates of the current processing node comprise an abscissa and an ordinate of the current processing node, the coordinates of the relay processing node comprise an abscissa and an ordinate of the relay processing node, the coordinates of the first reference node comprise an abscissa and an ordinate of the first reference node, and the coordinates of the second reference node comprise an abscissa and an ordinate of the second reference node; and
wherein determining the next processing node of the target service data comprises:
determining a first adjustment policy based on a relationship between the abscissa of the current processing node and the abscissa of the relay processing node;
determining a second adjustment policy based on a relationship between the ordinate of the current processing node and the ordinate of the relay processing node;
determining a third adjustment policy based on a relationship among the abscissa of the current processing node, the abscissa of the first reference node, and the abscissa of the second reference node;
determining a fourth adjustment policy based on a relationship among the ordinate of the current processing node, the ordinate of the first reference node, and the ordinate of the second reference node;
determining a fifth adjustment policy based on the first adjustment policy, the second adjustment policy, the third adjustment policy, and the fourth adjustment policy; and
determining coordinates of the next processing node based on the coordinates of the current processing node and the fifth adjustment policy.

8. The method according to claim 7, wherein determining the first adjustment policy comprises:
determining that the first adjustment policy is yes in a case that the abscissa of the current processing node is equal to the abscissa of the relay processing node; or
determining that the first adjustment policy is no in a case that the abscissa of the current processing node is not equal to the abscissa of the relay processing node.

9. The method according to claim 7, wherein determining the second adjustment policy comprises:
determining that the second adjustment policy is yes in a case that the ordinate of the current processing node is equal to the ordinate of the relay processing node; or
determining that the second adjustment policy is no in a case that the ordinate of the current processing node is not equal to the ordinate of the relay processing node.

10. The method according to claim 7, wherein determining the third adjustment policy comprises:
determining that the third adjustment policy is yes in a case that the abscissa of the current processing node is equal to the abscissa of the first reference node and the abscissa of the current processing node is not equal to the abscissa of the second reference node;
determining that the third adjustment policy is yes in a case that the abscissa of the current processing node is not equal to the abscissa of the first reference node and the abscissa of the current processing node is equal to the abscissa of the second reference node;
determining that the third adjustment policy is no in a case that the abscissa of the current processing node is not equal to the abscissa of the first reference node and the abscissa of the current processing node is not equal to the abscissa of the second reference node; or
determining that the third adjustment policy is no in a case that the abscissa of the current processing node is equal to the abscissa of the first reference node and the abscissa of the current processing node is equal to the abscissa of the second reference node.

11. The method according to claim 7, wherein determining the fourth adjustment policy comprises:
determining that the fourth adjustment policy is yes in a case that the ordinate of the current processing node is equal to the ordinate of the first reference node and the ordinate of the current processing node is not equal to the ordinate of the second reference node;
determining that the fourth adjustment policy is yes in a case that the ordinate of the current processing node is not equal to the ordinate of the first reference node and the ordinate of the current processing node is equal to the ordinate of the second reference node;
determining that the fourth adjustment policy is no in a case that the ordinate of the current processing node is not equal to the ordinate of the first reference node and the ordinate of the current processing node is not equal to the ordinate of the second reference node; and
determining that the fourth adjustment policy is no in a case that the ordinate of the current processing node is equal to the ordinate of the first reference node and the ordinate of the current processing node is equal to the ordinate of the second reference node.

12. The method according to claim 7, further comprising:
determining a current processing node as a termination processing node in a case that the fifth adjustment policy shows the current processing node is an end node for processing the target service data; and
transmitting data transmission termination information to the receiving node through the termination processing node in a case that the target service data is transmitted to the termination processing node.

13. The method according to claim 2, wherein the processing node set comprises nodes that are arranged in a rectangle manner, and an origin node located in a corner of the rectangle, and
wherein the first reference node is a node closest to the node located in lower left corner, and the second reference node is a node farthest from the node located in lower left corner.

14. The method according to claim 13, wherein the origin node is located in a lower left corner of the rectangle.

15. A node, configured in an NoC of an operation chip, wherein each node of the NoC is deployed in each processing unit of the NoC for data transmission between the processing units, and the node comprises:
a receiving unit comprises circuitry that is configured to receive a data processing instruction of target service data, wherein the data processing instruction carries information about a receiving node and a processing node set of the NoC, the receiving node being configured to receive the target service data and transmit to the processing node set, and the processing node set being configured to process the target service data;
a determination unit comprises circuitry that is configured to determine a relay processing node in the processing node set based on the receiving node, the relay processing node being configured to receive the target service data transmitted from the target service data; and
a transmission unit comprises circuitry that is configured to transmit the target service data from the receiving node to the relay processing node, and to transmit the target service data from the relay processing node to another processing node in the processing node set.

16. The node according to claim 15, wherein the determination unit includes circuitry configured to:
obtain coordinates of the receiving node, and obtaining coordinates of a first reference node and a second reference node in the processing node set, the first reference node and the second reference node being configured to collaboratively locate the processing node set;
determine coordinates of the relay processing node based on the coordinates of the receiving node, the coordinates of the first reference node, and the coordinates of the second reference node; and
determine the relay processing node based on the coordinates of the relay processing node.

17. The node according to claim 15, wherein the determination unit includes circuitry configured to:
determine an abscissa of the coordinates of the relay processing node based on an abscissa of the coordinates of the receiving node, an abscissa of the coordinates of the first reference node, and an abscissa of the coordinates of second reference node;
determine an ordinate of the coordinates of the relay processing node based on an ordinate of the coordinates of the receiving node, an ordinate of the coordinates of the first reference node, and an ordinate of the coordinates of the second reference node; and
determine coordinates of the relay processing node based on the abscissa and the ordinate of the relay processing node.

18. The node according to claim 17, wherein the determination unit includes circuitry configured to:
determine that the abscissa of the coordinates of the first reference node is the abscissa of the coordinates of the relay processing node in a case that the abscissa of the coordinates of the receiving node is less than or equal to the abscissa of the coordinates of the first reference node; and
determine that the abscissa of the coordinates of the second reference node is the abscissa of the relay processing node in a case that the abscissa of the coordinates of the receiving node is greater than the abscissa of the coordinates of the first reference node.

19. The node according to claim 17, wherein the determination unit includes circuitry configured to:
determining that the ordinate of the coordinates of the first reference node is the ordinate of the relay processing node in a case that the ordinate of the coordinates of the receiving node is less than or equal to the ordinate of the coordinates of the first reference node; and
determining that the ordinate of the coordinates of the second reference node is the ordinate of the relay processing node in a case that the ordinate of the coordinates of the receiving node is greater than the ordinate of the coordinates of the first reference node.

20. A processing unit, comprising:
a processor core; and
a node of an NoC, comprising:
a receiving unit comprises circuitry that is configured to receive a data processing instruction of target service data, wherein the data processing instruction carries information about a receiving node and a processing node set of the NoC, the receiving node being configured to receive the target service data and transmit to the processing node set, and the processing node set being configured to process the target service data;
a determination unit comprises circuitry that is configured to determine a relay processing node in the processing node set based on the receiving node, the relay processing node being configured to receive the target service data transmitted from the target service data; and
a transmission unit comprises circuitry that is configured to transmit the target service data from the receiving node to the relay processing node, and to transmit the target service data from the relay processing node to another processing node in the processing node set.

21. A system-on-chip (SoC), comprising:
a plurality of processing units, wherein each of the processing units comprises the node according to claim 15, the plurality of nodes form a routing node network, and the plurality of nodes are deployed in the plurality of processing units.
